(19) United States
(12) Patent Application Publication
(10) Pub. No.: US 2026/0354364 A1
(43) Pub. Date: Nov. 12, 2026

(54) PORTABLE SUCTION-MOUNTED FISHING ROD HOLDER

(71) Applicant: Jack Enkema, Cambridge, MA (US)

(72) Inventor: Jack Enkema, Cambridge, MA (US)

(21) Appl. No.: 19/656,102

(22) Filed: Apr. 23, 2026

Related U.S. Application Data
(60) Provisional application No. 63/802,431, filed on May 8, 2025.

(51) Int. Cl. A01K 97/10; F16B 47/00

(52) U.S. Cl. CPC A01K 97/10; F16B 47/006

(57) ABSTRACT

A portable suction-mounted holder device including a base body extending horizontally and having a generally rectangular profile, a suction cup mounted to an underside of the base body and centrally located along a length of the base body, and a series of support structures positioned along an upper surface of the base body. Each support structure forms a generally semi-circular guide with an opening, and the support structures are spaced apart along the length of the base body to support one or more articles. The suction cup enables removable attachment of the holder device to a surface, including a surface of a vehicle, a boat, or a window. In some implementations, the base body and the series of support structures are formed as a single integral structure. The holder device provides a portable, suction-mounted support arrangement that can be readily attached, removed, and repositioned for temporary storage or stabilization of supported articles.

### CROSS-REFERENCE TO RELATED APPLICATION

This application claims the benefit of U.S. Provisional Application No. 63/802,431 filed May 8, 2025, which is hereby incorporated by reference.

### FIELD OF THE INVENTION

The invention relates generally to portable suction-mounted fishing rod holder.

### BACKGROUND OF THE INVENTION

Currently, there are a few solutions for temporarily securing fishing rods to a surface during rigging or preparation. Some of these solutions attempt to use magnetic force to attach rod holders to vehicles or other surfaces, but these solutions fail to meet the needs of the industry because magnetic attachment is limited both by the material composition of the vehicle or boat, and by the specific surfaces available, such as non-metallic windows, fiberglass panels, and composite structures, thereby significantly reducing versatility. Other solutions attempt to provide open-top rod holders for quick access, but these solutions are similarly unable to meet the needs of the industry because the open design leaves rods vulnerable to being dislodged or blown out by wind, leading to potential equipment damage, personal injury, or property damage. Still, other solutions seek to offer portable rod security for anglers, but these solutions also fail to meet industry needs because they often involve higher manufacturing costs and increased retail pricing, which can discourage widespread adoption by anglers seeking affordable and simple equipment.

### SUMMARY OF THE INVENTION

It would be desirable to have a portable suction-mounted fishing rod holder that can securely attach to a wide variety of smooth surfaces such as cars, boats, and windows. Furthermore, it would be desirable to have a device that safely stabilizes fishing rods during rigging and preparation, preventing damage to the rods, vehicles, boats, or accidental injury to the user caused by falling rods or even swinging hooks. Still, further, it would also be desirable to have a device that is compatible with both fly-fishing rods and spinning rods. The disclosed device advantageously fills these needs and addresses the aforementioned deficiencies by providing a suction-mounted rod holder that offers secure, versatile support for fishing rods in various environments.

Disclosed is a portable suction-mounted fishing rod holder, which is made up of the following components, a base body, at least one suction cup, and at least two rod support structures positioned at opposite ends of the base. These components are connected as follows: the suction cup(s) is/are attached to the underside of the base body to allow the device to adhere to a smooth surface, and the rod support structures are formed with or connected to the base body in such a way that they help prevent a fishing rod from rolling or sliding sideways off the device.

The device may also have one or more of the following: two screw holes formed in the base body to allow for optional permanent or semi-permanent attachment of the device to a wall, workbench, shed, or other surface; any number of rod support structures or guides positioned along the base body to accommodate one or multiple fishing rods; and alternative suction cup sizes, shapes, or mounting configurations to accommodate different surface types and rod weights.

The disclosed device is unique when compared with other known devices and solutions because it provides: (1) a suction-based attachment system that can secure to a wide variety of smooth surfaces, including those that are non-metallic, such as glass and fiberglass; (2) rod support structures positioned and optionally lined to increase friction and stability, helping to prevent rods from being dislodged by wind or movement; and (3) a lightweight, simple, and cost-effective design that allows anglers to easily transport, set up, and use the device without damaging vehicles, boats, or other mounting surfaces.

The disclosed device is unique in that it is structurally different from other known devices or solutions. More specifically, the device is unique due to the presence of (1) a base body configured with at least one suction cup attached to its underside, enabling secure attachment to smooth surfaces without reliance on magnets or magnetic surfaces; (2) two or more rod support structures positioned along the base body, with the guides optionally oriented to face each other for added rod security; and (3) optional screw holes integrated into the base body, allowing the device to be converted from portable suction use to a semi-permanent or permanent wall-mounted rod holder when needed.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The portable suction-mounted fishing rod holder may, however, be embodied in many different forms and should not be construed as being limited to the embodiments set forth herein; rather, these embodiments are provided by way of illustration only and so that this disclosure will be thorough, complete and fully convey understanding to those skilled in the art.

Further forms, objects, features, aspects, benefits, advantages, and embodiments of the present invention will become apparent from a detailed description and drawings provided herewith.

### BRIEF DESCRIPTION OF THE DRAWINGS

FIG. 1 shows an isometric view of portable suction-mounted fishing rod holder.

FIG. 2 shows a side view of portable suction-mounted rod holder.

FIG. 3 shows a side view of an alternative embodiment of a suction-mounted fishing rod holder.

### DETAILED DESCRIPTION OF THE INVENTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

With respect to the specification and claims, it should be noted that the singular forms “a”, “an”, “the”, and the like include plural referents unless expressly discussed otherwise. As an illustration, references to “a device” or “the device” include one or more of such devices and equivalents thereof. It also should be noted that directional terms, such as “up”, “down”, “top”, “bottom”, and the like, are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

The present invention is directed to portable suction-mounted fishing rod holder.

In its most complete version, the device is made up of the following components: a base body, at least one suction cup, two or more rod support structures or guides, two optional screw holes, optional rubber or silicone lining within the guides, and an optional quick-release mechanism for the suction cup(s). These components are connected as follows: the suction cup(s) are attached to the underside of the base body to allow the device to adhere securely to a smooth surface; the rod support structures are integrated into or connected to the base body and are positioned along the base to hold one or multiple fishing rods; the screw holes are formed into the base body to enable optional permanent attachment to a wall or similar surface after the suction cups are removed; the rubber or silicone lining is positioned within the rod support structures to increase friction and help prevent rod slippage; and the quick-release mechanism is attached to the suction cup(s) to facilitate easy detachment from the mounting surface without excessive force.

It should further be noted that: the device may be manufactured using durable materials to withstand outdoor conditions; the suction cups may vary in size and shape to accommodate different rod sizes and environmental conditions; the rod support structures may be of varying shapes and dimensions to fit fly rods, spinning rods, or other fishing rod types; and the connection methods for the various components (such as suction cup mounts or rod guides) may involve mechanical fastening, adhesive bonding, integral molding, or other standard fabrication techniques.

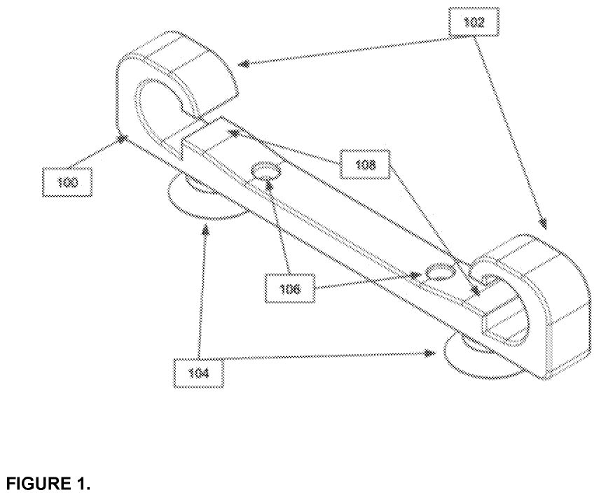

FIG. 1 is an isometric view of a fishing rod holder device constructed in accordance with the present invention. The device generally includes a base body (100) extending longitudinally, having a generally rectangular and slightly contoured profile. Integrated into or formed with the base body (100) are two opposing rod support structures (102), located near opposite ends of the base. Each rod support structure (102) features a u-shaped guide with an open slot (108) oriented toward the opposing guide, creating a configuration that stabilizes a fishing rod and prevents it from rolling or sliding laterally off the device.

Mounted to the underside of the base body (100) are two suction cups (104), spaced apart along the length of the device, configured to enable secure attachment to a smooth surface such as a vehicle, boat, or window. The suction cups (104) are illustrated in a compressed state, showing their connection beneath the base and their general circular footprint. The base body (100) may optionally include screw holes (106) for alternative mounting via mechanical fasteners if needed. These holes extend fully through the base (100). The entire structure is shown in a single, integral form, which may be manufactured by molding, injection molding, or other fabrication processes. The drawing emphasizes the relative placement, shape, and orientation of the guides (102), suction cups (104), and base body (100), providing a clear visual representation of the device's portable, suction-based design for stabilizing fishing rods during rigging, preparation, or storage.

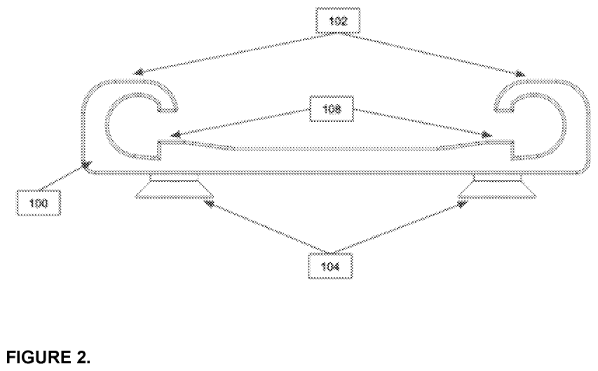

FIG. 2 is a side view of a fishing rod holder device constructed in accordance with the present invention. The device includes a base body (100) extending horizontally and forming the primary longitudinal structure of the device. The base body (100) has a generally rectangular profile with a slightly contoured upper surface to enhance rigidity and provide a central support axis.

Positioned at opposite ends of the base body (100) are rod support structures (102), each forming a substantially u-shaped guide. These rod support structures (102) are elevated above the base body (100) and are integrally formed or connected thereto. Each rod support structure (102) features an open slot (108) facing inward toward the opposite rod support structure (102), forming an opposed configuration that enables the device to cradle a fishing rod while minimizing the risk of lateral displacement caused by wind or unintentional movement.

Mounted to the underside of the base body (100) are two suction cups (104), spaced symmetrically apart along the longitudinal axis. The suction cups (104) are depicted in an engaged or compressed state, illustrating their broad, circular contact areas configured to maximize adhesion to a smooth, non-porous surface such as a vehicle, boat, or window. The suction cups (104) extend downward from the base body (100) and operate to maintain the device in a stable, upright position during use.

The figure emphasizes the elevated and symmetrical arrangement of the rod support structures (102) relative to the base body (100), the parallel alignment of the suction cups (104) beneath the base body (100), and the orientation of the guide openings (108) facing toward one another to enhance rod retention and overall device stability. The side elevation view highlights the low-profile, streamlined nature of the device, making it highly portable and adaptable for various angling and storage environments.

It should be noted that while screw holes (106 from FIG. 1) may be present in the base body (100) to allow for optional permanent or semi-permanent mounting, they are not visible in the side elevation view depicted in FIG. 2.

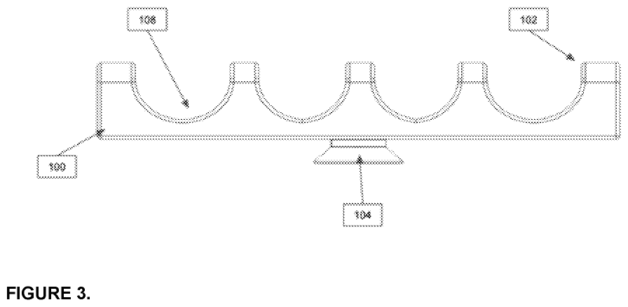

FIG. 3 is a side view of an alternative embodiment of a fishing rod holder device constructed in accordance with the present invention. The device includes a base body (100) extending horizontally and forming the primary longitudinal structure of the device. The base body (100) has a generally rectangular profile designed to provide strength and stability while supporting multiple rod support structures along its length.

Positioned along the upper surface of the base body (100) are a series of rod support structures (102), each forming a generally semi-circular guide with an opening (108). The rod support structures (102) are spaced apart along the length of the base body (100) and are integrally formed or connected thereto. Each rod support structure (102) features an opening (108) sized and shaped to cradle a fishing rod while minimizing lateral rolling or displacement during rigging or storage.

Mounted to the underside of the base body (100) is a single centrally located suction cup (104). The suction cup (104) is depicted in an engaged or compressed state, showing its broad contact surface configured to maximize adhesion to a smooth surface such as a vehicle, boat, or window. The central placement of the suction cup (104) enables balanced support for the base body (100) and any fishing rods held within the rod support structures (102). The figure illustrates an alternative configuration of the device in which multiple rods may be supported in a parallel arrangement, utilizing a single suction cup (104) for attachment, and multiple rod support structures (102) each featuring their own opening (108). This alternative embodiment highlights that the invention is not limited to devices with two opposing rod guides, nor to configurations requiring two suction cups.

It should be noted that while screw holes (106 from FIG. 1) may be optionally incorporated into the base body (100) to allow for permanent or semi-permanent mounting, they are not visible in the side elevation view depicted in FIG. 3. Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A portable suction-mounted holder device, comprising:
a base body extending along a length and having a generally rectangular shape;
at least one suction cup mounted to an underside of the base body and centrally located along the length of the base body; and
a plurality of support structures positioned along an upper surface of the base body, extending away from the upper surface of the base body, and spaced apart along the length of the base body, each support structure defining a u-shaped guide with an opening.

2. The holder device of claim 1, wherein the plurality of support structures are configured to hold at least one fishing rod.

3. The holder device of claim 1, wherein, when the at least one suction cup is mounted to a support surface, the base body extends horizontally relative to the support surface.

4. The holder device of claim 1, wherein the plurality of support structures are integrally formed with the base body.

5. The holder device of claim 1, wherein the at least one suction cup is configured to adhere to a smooth surface.

6. The holder device of claim 1, wherein at least one of the plurality of support structures includes a rubber or silicone lining.

7. The holder device of claim 1, wherein the at least one suction cup comprises a quick-release mechanism.

8. The holder device of claim 1, wherein at least two of the u-shaped guides have different dimensions.

9. The holder device of claim 1, wherein the plurality of support structures extend away from the upper surface substantially perpendicular to the base body.

10. A portable suction-mounted holder device, comprising:
a base body extending horizontally and having a generally rectangular profile;
a single suction cup mounted to an underside of the base body and centrally located along a length of the base body; and
a series of support structures positioned along an upper surface of the base body, extending away from the upper surface of the base body, and spaced apart along the length of the base body, each of the support structures forming a u-shaped guide with an opening.

11. The holder device of claim 10, wherein the series of support structures are configured to hold at least one fishing rod.

12. The holder device of claim 10, wherein the suction cup is configured to adhere to a surface of a vehicle.

13. The holder device of claim 10, wherein the base body and the series of support structures are a single integral structure.

14. The holder device of claim 10, wherein at least two of the u-shaped guides have different dimensions.

15. The holder device of claim 10, wherein the series of support structures extend away from the upper surface substantially perpendicular to the base body.

16. A portable suction-mounted holder device, comprising:
a base body extending longitudinally;
a first support structure and a second support structure positioned along the base body and spaced apart from one another, each of the first support structure and the second support structure including a guide defining an opening; and
at least one suction cup attached to an underside of the base body.

17. The holder device of claim 16, wherein the first and second support structures are configured to hold at least one fishing rod.

18. The holder device of claim 16, wherein each of the first and second support structures comprises a u-shaped guide with an open slot.

19. The holder device of claim 18, wherein the open slot of the first support structure is oriented toward the second support structure, and the open slot of the second support structure is oriented toward the first support structure.

20. The holder device of claim 16, wherein the at least one suction cup includes two suction cups spaced apart along a length of the base body.
